(19) United States
(12) Patent Application Publication
(10) Pub. No.: US 2018/0330549 A1
(43) Pub. Date: Nov. 15, 2018

(54) EDITING INTERACTIVE MOTION CAPTURE DATA FOR CREATING THE INTERACTION CHARACTERISTICS OF NON PLAYER CHARACTERS

(71) Applicant: Bespoke VR Limited, Harrow Middlesex (GB)

(72) Inventor: Harry William Donald BRENTON, Cambridge Cambridgeshire (GB)

(21) Appl. No.: 15/776,129

(22) PCT Filed: Nov. 16, 2016
(86) PCT No.: PCT/IB2016/056897

§ 371 Date: May 15, 2018

(30) Foreign Application Priority Data
Nov. 19, 2015 (GB) 1520367.2

(51) Int. Cl. G06T 19/20; G06T 13/40; A63F 13/65; G06N 7/00; G06F 3/01

(52) U.S. Cl. CPC G06T 19/20; G06T 13/40; G06F 3/011; G06N 7/005; A63F 13/65

(57) ABSTRACT

A system includes a processor configured to provide an immersive virtual environment wherein first and second users can view and edit interaction data corresponding to interactive motion capture for first and second performers who interact with one another in a performance corresponding to the interaction between first and second characters, so as to edit the interaction between the first and second characters and thereby provide edited data corresponding to the performance.

### FIELD

The present disclosure is directed to editing interactive motion capture data for creating the interaction characteristics of Non Player Characters.

### BACKGROUND

Computer games may include Non Player Characters (NPCs) that perform a pre-recorded activity in response to one or more particular actions by a player or user of the game. Motion capture can be used to collect data to permit NPCs to replay pre-recorded performances within the computer game. Current techniques work well for non-immersive displays and the limited range of interaction provided by a gamepad, mouse or keyboard. However motion capture works badly within interactive immersive environments because NPCs fail to respond moment-by-moment to a user's body language with the subtle interactive gestures that are taken for granted when meeting people in everyday life. Because NPCs in immersive environments are life-sized, users can interpret this lack of interaction as a negative social cue. The result in an unsatisfactory user experience that feels cold, impersonal and emotionless.

Efforts have been made to solve this problem using interactive machine learning techniques that extract interaction data from two actors rehearsing a scene together. This is a promising approach for capturing raw interaction data. However, actors and directors cannot presently edit this data into an interactive performance without assistance from a computer scientist.

### SUMMARY

In one embodiment of the invention there is provided a method comprising: providing interaction data corresponding to interactive motion capture for first and second performers who interact with one another in a performance corresponding to the interaction between first and second characters, and providing an immersive virtual environment wherein first and second users can view and edit the interaction data so as to edit the interaction between the first and second characters and thereby provide edited data corresponding to the performance.

In this way, a technique is provided that allows interactive motion capture to be edited in a natural way by actors and directors using their body movements without having to leave the immersive environment.

In another aspect an embodiment of the invention provides a system comprising: a processor to provide an immersive virtual environment wherein first and second users can view and edit interaction data corresponding to interactive motion capture for first and second performers who interact with one another in a performance corresponding to the interaction between first and second characters, so as to edit the interaction between the first and second characters and thereby provide edited data corresponding to the performance.

The invention also provides a computer program product including a storage medium that stores program code for performing the aforesaid method.

### BRIEF DESCRIPTION OF THE DRAWINGS

In order that the invention can be more fully understood, embodiments thereof will now be described by way of illustrative example with reference to the accompanying drawings in which:

FIG. 1 is a block diagram of an exemplary media device for full body editing of interaction data to control the performance of an NPC within an immersive multi-user environment;

FIG. 2 is a block diagram of an exemplary user device for full body editing of interaction data to control the performance of an NPC within an immersive multi-user environment;

FIG. 3 is an exemplary diagram illustrating a method for determining and transmitting interaction data to control the performance of an NPC within an immersive multi-user environment;

FIG. 4 illustrates an example of a method of viewing and annotating interaction data to control the performance of an NPC within an immersive multi-user environment;

FIG. 5 illustrates an example of a method of full body editing of interaction data to control the performance of an NPC within an immersive multi-user environment;

FIG. 6 presents an exemplary diagram illustrating a method for a single user interacting with an NPC whose performance is derived from interaction data created with full body editing; and

FIG. 7 is an exemplary flowchart illustrating a method for full body editing of interaction data that controls the performance of an NPC within an immersive multi-user environment.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations are generally not to scale, and are not intended to correspond to actual relative dimensions.

Virtual Reality (VR) immerses a user in a computer-generated world allowing them to experience an artificial, three dimensional world using the body's sensory systems. Augmented reality (AR) differs from virtual reality because it supplies digital information on top of what the user sees in the real world—whereas VR creates a 100% digital environment from scratch. The term Immersive environment' in this document refers to both virtual reality and augmented reality.

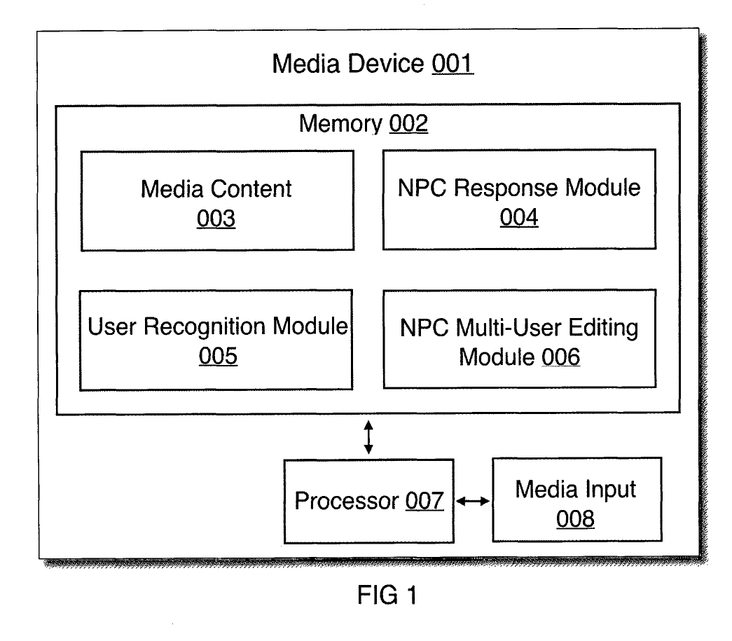

FIG. 1 presents an exemplary media device for determining and transmitting data for full body editing of the behaviour of an NPC within an immersive multi-user environment. According to FIG. 1, Media Device 001 includes Memory 002, Processor 007 and Media Input 008. Additionally, Memory 002 of Media Device 001 is shown containing Media Content 003, NPC Response Module 004, User Recognition Module 005 and NPC Multi-User Editing Module 006. Media Device 001 may correspond to a video game console, desktop computer, laptop computer, mobile phone, tablet, head mounted display, or other device.

As shown in FIG. 1, Media Device 001 includes Processor 007 in connection with Memory 002. Processor 007 of Media Device 001 is configured to access Memory 002 to store and receive input and/or execute commands, processes or programs stored in Memory 002. Processor 007 may receive content, such as interactive video games, virtual reality/augmented reality simulations, virtual reality/augmented reality experiences, cinematic sequences, user generated content and other media content, from Media Input 008. Media Input 008 is shown residing on Media Device 001 and may refer generally to media content, input received through input means, such as a CD/DVD/Blu-ray player, USB port, storage port or other form of media content input. However, in other implementations, Media Input 008 may include network communication connections, such as wireless, radio, ethernet or other network communication. Thus Media Input 008 may include media content received over a network communication. Processor 007 may store Media Input 008 in Memory 002 and Media Content 003. Media Content 003 may correspond to media content downloaded for persistent storage in Memory 002 from Media Input 008. However in other implementations, Media Content 003 may correspond to to data received from other input means, such as read from CD/DVD/Blu-ray disk during use. Thus Media Input 008 may correspond to data received from attached devices and/or networks.

Processor 007 may also access Memory 002 and execute programs, processes and modules stored in Memory 002, such as NPC Response Module 004 and/or User Recognition Module 005 and/or NPC Multi-User Editing Module 006. Additionally, Processor 007 may store in Memory 002 data resulting from executed programs, processes and modules. Processor 007 may correspond to a processing device, such as a microprocessor or similar hardware processing device, or a plurality of hardware devices. However, in other implementations Processor 007 refers to a general processor capable of performing the functions required by Media Device 001.

Memory 002 of Media Device 001 corresponds to a sufficient memory capable of storing commands, processes, and programs for execution by Processor 007. Memory 002 may be instituted as ROM, RAM, flash memory, or any sufficient memory capable of storing a set of commands. In other implementations, Memory 002 may correspond to a plurality of memory types or modules. Processor 007 and Memory 002 contain sufficient memory and processing units necessary for Media Device 001. Although Memory 002 is shown as located on media Media Device 001, in other implementations, Memory 002 may be separate but connectable to Media Device 001.

User Recognition Module 005 is stored in Memory 002 of Media Device 001. User Recognition Module 005 may correspond generally to processes and procedures utilised to train the behaviour of a NPC from motion capture data from one or more users. User Recognition Module 005 may be utilised to extract meaningful features from the Device Sensors 010 shown in User Device 009. User Recognition Module 005 may also utilise face perception technology or other image recognition technology to determine data corresponding to one or more user's movement and behaviour.

A technique that may be used is described in the following publications:

1) Gillies, Marco. 2009. Learning Finite State Machine Controllers from Motion Capture Data. IEEE Transactions on Computational Intelligence and AI in Games, 1(1), pp. 63-72. ISSN 1943-068X;
2) Gillies, Marco. 2010. ‘Bodily Non-verbal Interaction with Virtual Characters’,
3) Gillies Marco, Brenton Harry, Kleinsmith Andrea. 2015. Embodied design of full bodied interaction with virtual humans. First International Workshop on Movement and Computing 2015, each of which is incorporated herein by reference.

These papers describe a data-driven learning approach to capturing data and that can be used to create a NPC capable of non-verbal bodily interaction with a human. They describe machine learning methods applied to motion capture data as way of doing this. For example, they present a method for learning the transition probabilities of a Finite State Machine and also how to select animations based on the current state. In one example a Dynamic Bayesian network such as a Hidden Markov Model is used to process motion capture data to permit selection of motion clips from a motion graph. In another example, a conditional random field technique may be used.

NPC Response Module 004 is stored in Memory 002 of Media Device 001. It determines the behaviour of the NPC in response to the user's body language.

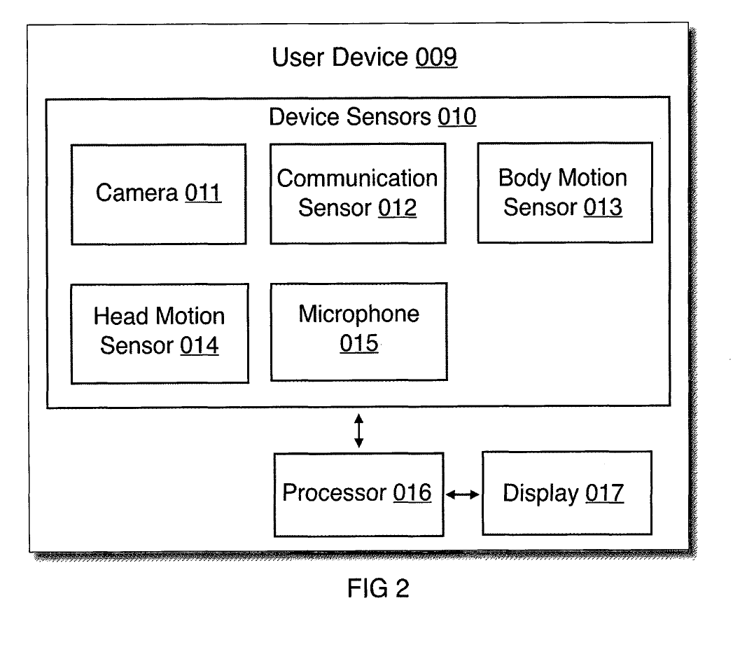

FIG. 2 presents an exemplary user device for full body interaction with a Non Player Character within an immersive multi-user environment. User Device 009 includes Device Sensors 010 Processor 016 and Display 017. Additionally, Device Sensors 010 of User Device 009 are shown containing Communication Sensors 012, Camera 011, Body Motion Sensor 013, Head Motion Sensor 014 and Microphone 015.

In some implementations User Device 009 will include Display 017 which may correspond to a head mounted display, near-eye light field display, waveguide reflector array projector, lenticular display, liquid crystal display panel, light emitting diode display panel, plasma display panel, cathode ray tube or other display. Display 017 may correspond to a visual display unit capable of presenting and rendering VR media content for a user.

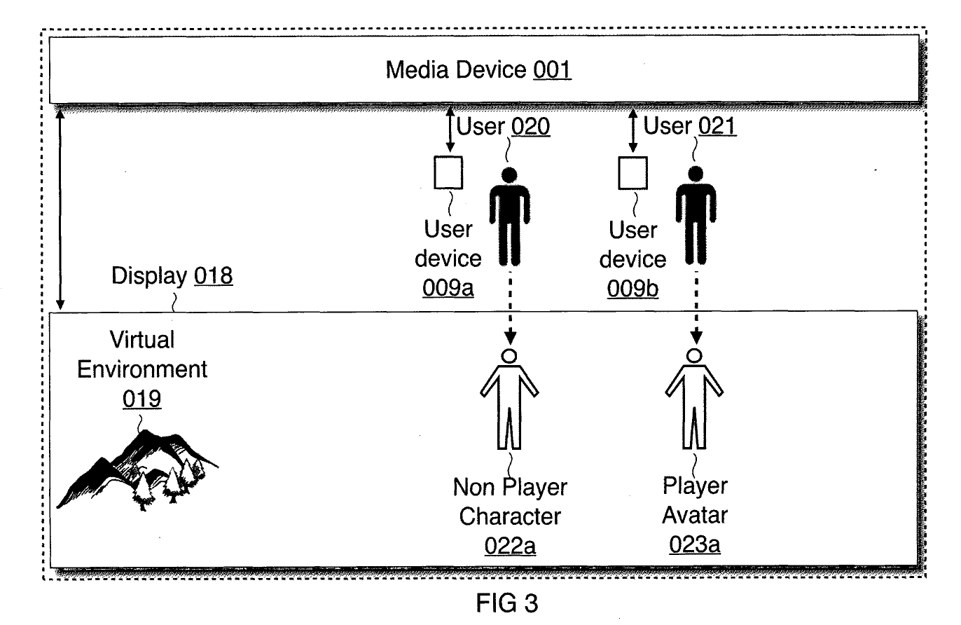

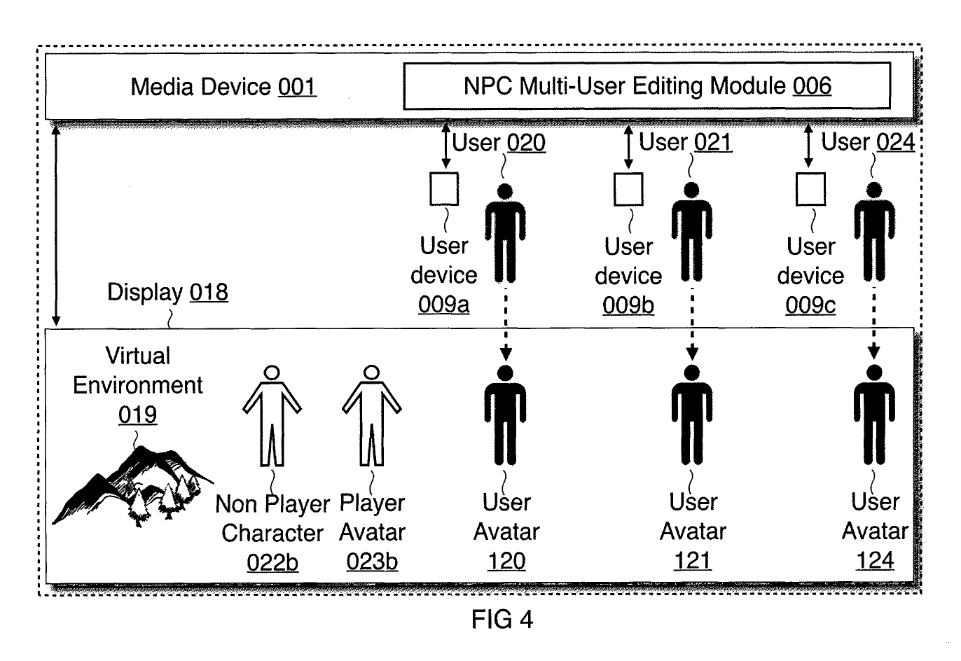

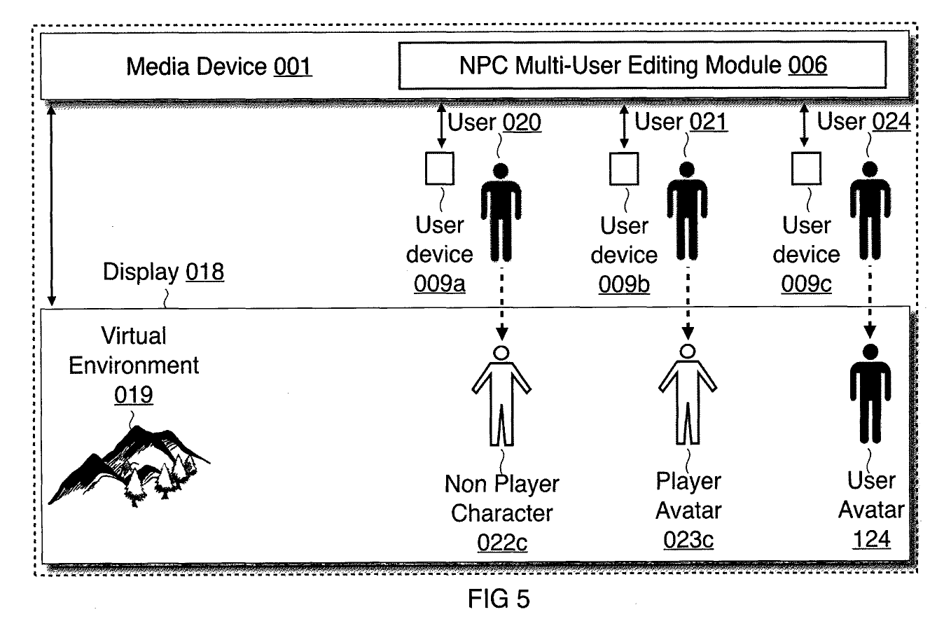

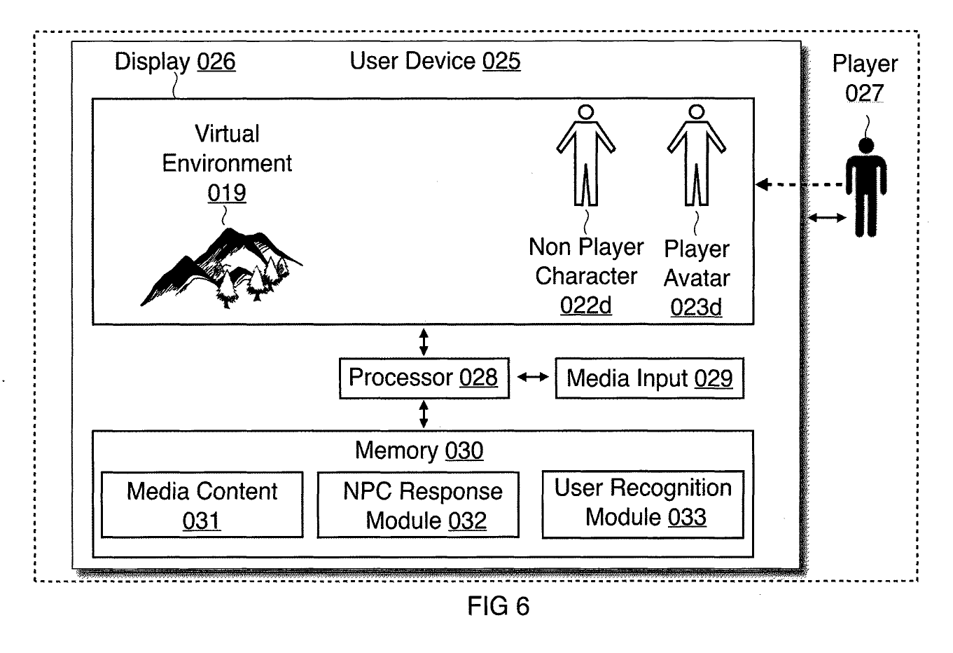

User 020 and User 021 shown in FIG. 3 wear User Device 009a and User Device 009b which may be identical versions of User Device 009 shown in FIG. 2. Camera 011 and Microphone 015 are mounted on a headcam consisting of a helmet, camera mounting bar, helmet to belt wiring harness and camera belt. Body motion capture data from Body Motion Sensor 013, Head motion capture data from Head Motion Sensor 014, video from Camera 011 and sound from Microphone 015 are sent through a wired connection to Media Device 001, or sent wirelessly to Media Device 001 using Communication Sensors 012. The video data from Camera 011 is then processed to extract motion data from facial features such as the eyes and the mouth. Body, head and face data is then mapped onto the facial and body movements of the Avatar displayed on display 018 in FIG. 3, FIG. 4, FIG. 5 and FIG. 6.

An implementation of the equipment described above is shown in FIG. 3. The process of generating the interaction data shown in FIG. 3 is described below using an example of a scene in a computer game where a suspect has been arrested for a robbery and is being interrogated by a police officer. User 020 is an actor playing the role of Non Player Character 022a (the police officer), and User 021 is an actor playing the role of the Player Avatar 023a (the suspect). Data from User Device 009a is connected to Non Player Character 022a and is used to animate the behaviour of Non Player Character 022a. Data from User Device 009b is connected to Player Avatar 023a and is used to represent the sensor input that will come from Player 027 in FIG. 6. The performance is visible in real-time on Display 018 which shows an interrogation room in a police station as the Virtual Environment 019. The display 018 and virtual environment 019 are provided in this example by the immersive display 017 worn by each user, although other non-immersive displays could also be used.

This scene has four sections:
1. Confrontation. The police officer presents the facts of the case and informs the suspect of the evidence against them.
2. Theme development. The police officer creates a story about why the suspect committed the crime.
3. Denial. The suspect denies their guilt and the police officer pretends to be the suspects ally.
4. Confession. The police officer increases the pressure and the suspect loses their resolve and confesses to the robbery.

User 020 and User 021 start by recording the confrontation section. They record the three different takes: 1) the suspect is reacts angrily and unhelpfully towards the police officer; 2) the suspect is compliant and engaging with the police officer; 3) the suspect is non communicative and withdrawn. The system records the interaction data and audio for these three takes using user device 009a and user device 009b. They then record the rest of the sections in the scene.

The data from User Device 009a and User Device 009b is synchronised and sent to User Recognition Module 005 of Media Device 001 where it is processed by Processor 007 using techniques such as those described in Gillies 2009, Gillies 2010 and Gillies 2015, to provide interaction data which characterises the interaction between the characters represented by Non Player Character 022a and Player Avatar 023a. The resulting interaction data is stored in the memory 002 of the media device 001.

The process of viewing and annotating the interaction data shown in FIG. 4 is described below continuing the previous example of a scene in a computer game where a suspect has been arrested for a robbery and is being interrogated by a police officer. User 020 (who previously played the police officer/Non Player Character 022a) and User 021 (who previously played the suspect/Player Avatar 023a) remain within Virtual Environment 019 but are now represented by User Avatar 120 and User Avatar 121. They are joined by User 024 who is the director of the video game, who is represented within Virtual Environment 019 by User Avatar 124. User 024 may, for example, wear User device 009 with a display 017 configured to display the virtual environment 019 also experienced by the users 020, 021 on their respective displays 017. User avatar 120, User Avatar 121 and User Avatar 124 may be avatars with a full human body, or a partial or iconic representation of a human. The Virtual Environment 019 may also contain graphical representations of meta-data that support editing such as timecode and scrub bar controls that allows user to control animation playback.

User 020, User 021 and User 024 can have access to controls that allow them to view the different takes of the interrogation scene that were previously recorded in FIG. 3. The controls also allow the users to pause, rewind, fast forward and scrub through the recordings. These controls may be a physical device such as joypad, keyboard, or oculus touch. Or they may be gestural controls performed using physical movements.

User 020, User 021 and User 024 view, annotate and markup all the recordings previously recorded in FIG. 3. Annotations may describe higher level information about a behaviour such as a smile, or emotions and communicative functions such as ‘a guilty grin’ or a combination of both. For example, in one take of the confrontation section of the interrogation they annotate body language where the suspect (played by user 021) is non communicative and withdrawn. Annotations also describe paired interactions between first and second performers, for example an annotation may describe how a ‘guilty grin’ from Player avatar 023b is responded to by aggressive hand gestures from Non Player Character 022b.

These annotations sent for processing by the NPC multi-User Editing Module 006 where they provide labels and/or general supervision and/or general metadata for use by the machine learning algorithms using techniques described in Gillies 2009, Gillies 2010 and Gillies 2015, for example, or those skilled in the art will readily appreciate that other machine learning techniques can be used.

The process of full body editing of interaction data to control the behaviour of an NPC within an immersive multi-user environment shown in FIG. 5 is described below. It continues the previous example of a scene in a computer game where a suspect has been arrested for a robbery and is being interrogated by a police officer.

User 020, user 021 and user 024 review four recordings of the confrontation section of the interrogation where the suspect (played by user 021) is interviewed by the police officer (played by user 020). They use the previously recorded annotations (see FIG. 4) as an index to access relevant sections of the interaction data. For example they review all moments in the confrontation scene with labels indicating that the police officer's body language becomes more friendly and inviting in response to the suspect being withdrawn and defensive. They particularly like the acting in the second of these recordings, however they decide that the police officer's posture should be even more positive and approachable.

Therefore user 021 steps in to take control of the suspect (Player Avatar 023c) and physically acts out that section of the performance with more open and inviting body language. These revisions refine the existing interaction data and do not completely replace it, such that the body posture of the suspect is altered, but the rest of the performance e.g. eye contact, head movements and speech, are left as they were. These edited revisions are sent for processing by the NPC multi-User Editing Module 006 where they update the data to provide edited interaction data corresponding to the performance. This edited interaction data can be stored for subsequent use, for example in a computer game in which a NPC interacts with a player in accordance with the edited interaction data.

The process of a single player interacting with an NPC whose performance is derived from the edited interaction data shown in FIG. 6 is described below. It continues the previous example of a scene in a computer game where a suspect has been arrested for a robbery and is being interrogated by a police officer.

Player 027 wears user device 025 which may correspond to a head mounted display, near-eye light field display, waveguide reflector array projector, lenticular display, liquid crystal display panel, light emitting diode display panel, plasma display panel, cathode ray tube or other display. User device 025 immerses Player 027 within virtual environment 019 which represents the interior of a police station. The facial and body movements of Player 027 are connected to Player Avatar 023d, which may be an avatar with a full human body, or a partial or iconic representation of a human.

Player 027 then experiences the scenario that was previously recorded, annotated & edited by User 20, User 21 and User 24, in the process shown in FIGS. 3, 4 and 5 and described above. Player 027 experiences the scenario from the perspective of the suspect whose body language is responded to, moment-by-moment, by Non Player Character 022d. For example, during the confrontation scene, player 027's body language becomes withdrawn and defensive. The NPC recognises this behaviour and is triggered to behave in a more positive and approachable way, using the section of the performance that was recorded in FIG. 3, annotated in FIG. 4 and edited in FIG. 5.

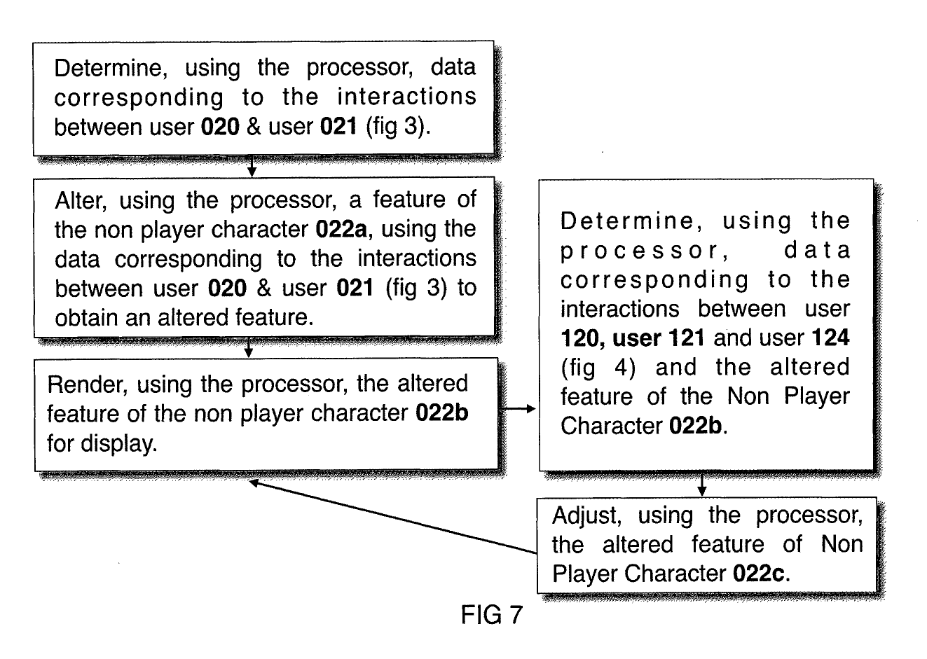

The method of full body editing of the behaviour of a NPC within an immersive multi-user environment shown as a flowchart FIG. 7 is described below. Stages 3,4 and 5 are cyclical, and can be repeated as long as is necessary to edit the interaction data.
1. Determine, using the processor, data corresponding to the interactions between user 020 & user 021 (FIG. 3).
2. Alter, using the processor, a feature of the non-player character 022a, using the data corresponding to the interactions between user 020 & user 021 (FIG. 3) to obtain an altered feature.
3. Render, using the processor, the altered feature of the non-player character 022b for display.
4. Determine, using the processor, data corresponding to the interactions between user 120, user 121 and user 124 (FIG. 4) and the altered feature of the Non Player Character 022b.
5. Adjust, using the processor, the altered feature of Non Player Character 022c.

From the foregoing, it will be understood that edited interaction data for the interrogation of a suspect by a police officer is just one example of a performance for which interaction data may be edited, and that data corresponding to a plurality of different performances can be established and stored for subsequent use in computer games or other entertainment media, to provide a library of animation for different user/player interactions, which has been edited to provide a natural and realistic interaction, by a technique which does not require complex program code editing techniques and can be carried by actors and/or a director rather than a software engineer.

Many modifications and variations of the described embodiments are possible that fall within the scope of the invention as set forth in the claims hereinafter.

1. A computer-implemented method comprising:
providing interaction data corresponding to interactive motion capture for first and second performers who interact with one another in a performance corresponding to the interaction between first and second characters, and
providing an immersive environment
wherein first and second users can view and edit the interaction data so as to edit the interaction between the first and second characters and thereby provide edited interaction data corresponding to the performance.

2. A method as claimed in claim 1 wherein the interaction data is provided by a given functional relationship between movement of the first and second performers, and wherein the editing of the interaction data modifies said given functional relationship.

3. A method as claimed in claim 2 wherein the functional relationship is provided by a statistical machine learning algorithm.

4. A method as claimed in claim 2 wherein the said given functional relationship at least in part includes a Dynamic Bayesian Network.

5. A method as claimed in claim 2 wherein the given functional relationship at least in part includes a Hidden Markov Model.

6. A method as claimed in claim 2 wherein the given functional relationship is at least in part provided by a conditional random field technique.

7. A method as claimed in claim 1 wherein the immersive virtual environment is configured so that a third user can view and edit the interaction data to provide edited data corresponding to the performance.

8. A method as claimed in claim 1 wherein the editing of the interaction data is performed iteratively.

9. A system comprising: a processor configured to provide an immersive virtual environment wherein first and second users can view and edit interaction data corresponding to interactive motion capture for first and second performers who interact with one another in a performance corresponding to the interaction between first and second characters, so as to edit the interaction between the first and second characters and thereby provide edited data corresponding to the performance.

10. A system as claimed in claim 9 including an input to receive the interaction data.

11. A system as claimed in claim 9 including a display device operable to provide said immersive environment and controls operable by the first and second users to edit the interaction between the first and second characters displayed by said display device.

12. A system as claimed in claim 11 wherein the display device is operable to display metadata corresponding to the interaction data to facilitate editing thereof.

13. A system as claimed in claim 11 wherein the display device comprises: a head mounted display, near-eye light field display, waveguide reflector array projector, lenticular display, liquid crystal display panel, light emitting diode display panel, plasma display panel or cathode ray tube.

14. A computer program product including: a non-transitory computer readable storage medium that stores code operable by a processor to provide an immersive virtual environment wherein first and second users can view and edit interaction data corresponding to interactive motion capture for first and second performers who interact with each other in a performance corresponding to the interaction between first and second characters, so as to edit the interaction between the first and second characters and thereby provide edited data corresponding to the performance.

15. A computer program product as claimed in claim 14 operable to receive the interaction data corresponding to interactive motion capture for first and second performers who interact with each other in a performance.

16. A computer program product as claimed in claim 14 including a multi user editing module which controls the viewing, annotating and editing of the interaction data.
